(19) United States
(12) Patent Application Publication
(10) Pub. No.: US 2026/0141809 A1
(43) Pub. Date: May 21, 2026

(54) METHOD FOR CONTROLLING A VEHICLE

(71) Applicant: Robert Bosch GmbH, Stuttgart (DE)

(72) Inventors: Johannes Christian Mueller, Stuttgart (DE); Thomas Schlender, Renningen (DE)

(21) Appl. No.: 19/381,274

(22) Filed: Nov. 6, 2025

(30) Foreign Application Priority Data
Nov. 18, 2024 (DE) 10 2024 211 027.2

(51) Int. Cl. G08G 1/16; B60T 7/22; G08G 1/01

(52) U.S. Cl. CPC G08G 1/16; B60T 7/22; G08G 1/0112; G08G 1/0133

(57) ABSTRACT

A computer-implemented method for controlling a vehicle. The method includes: receiving environmental sensor data of at least one environmental sensor of the vehicle by a control unit of the vehicle, wherein the environmental sensor data at least partially represent an environment of the vehicle; ascertaining a potentially safety-critical traffic situation based on the environmental sensor data by a traffic situation assessment module of the control unit; and providing control signals by the control unit for executing signal braking, wherein the signal braking has a degressive deceleration profile.

### CROSS REFERENCE

The present application claims the benefit under 35 U.S.C. § 119 of Germany Patent Application No. DE 102024 211 027.2 filed on November 18, 2024, which is expressly incorporated herein by reference in its entirety.

### FIELD

The present invention relates to a method for controlling a vehicle.

### BACKGROUND INFORMATION

Certain methods for controlling vehicles are described in the related art.

It is an object of the present invention to provide an improved method for controlling a vehicle.

The object may be achieved by a method having certain features of the present invention. Advantageous embodiments of the present invention are disclosed herein.

### SUMMARY

According to one aspect of the present invention, a computer-implemented method for controlling a vehicle is provided. According to an example embodiment of the present invention, the method includes:

Receiving environmental sensor data of at least one environmental sensor of the vehicle by a control unit of the vehicle, wherein the environmental sensor data at least partially represent an environment of the vehicle;

Ascertaining a potentially safety-critical traffic situation based on the environmental sensor data by a traffic situation assessment module of the control unit; and

Providing control signals by the control unit for executing signal braking, wherein the signal braking is configured to reduce a speed of the vehicle and has a degressive deceleration profile.

This can achieve a technical advantage that an improved method for controlling a vehicle can be provided. For this purpose, a potentially safety-critical traffic situation is ascertained based on environmental sensor data of at least one environmental sensor, and control signals are subsequently output for executing signal braking. Here, the signal braking has a degressive deceleration profile. Due to the signal braking, the speed of the vehicle can be reduced and the vehicle can, if applicable, be prevented from encountering the safety-critical traffic situation. In addition, by creating a temporarily increased dynamic (by means of a short, strong deceleration) in conjunction with a degressive deceleration profile, a driver of the vehicle can be alerted to the potentially safety-critical traffic situation, if applicable.

In the sense of the present application, a signal braking is a braking process of the vehicle. Here, however, signal braking is not primarily used to reduce the speed of the vehicle. Instead, a main intention of signal braking is to signal to the driver of the vehicle and/or to other road users that a potential safety hazard may occur in the current traffic situation.

A potentially safety-critical traffic situation within the meaning of the present application is a traffic situation having a safety hazard potential that reaches or exceeds a predefined threshold value. Here, the safety hazard potential is a probability value indicating the likelihood of a safety hazard being present in the traffic situation.

A traffic situation is a situation that an ego vehicle may encounter in road traffic. Here, the traffic situation can comprise various factors such as: other road users, visibility conditions, weather conditions, roadway conditions, traffic volume, driving maneuvers of the ego vehicle and/or of the other road users, etc.

According to one example embodiment of the present invention, due to the signal braking, a deceleration with a noticeable jerk is initiated.

This can achieve a technical advantage that the abrupt initiation of deceleration can alert the driver to the ascertained potentially safety-critical traffic situation.

According to one example embodiment of the present invention, due to the signal braking, a brake light of the vehicle is activated.

This can achieve a technical advantage that the activated brake light can inform other road users positioned behind the vehicle in the direction of travel of the, if applicable, potentially safety-critical traffic situation. This can further increase the safety of the control of the vehicle. By signaling the potentially safety-critical traffic situation to other road users, in particular those positioned behind the vehicle in the direction of travel, the safety-critical situation can be defused so that road users positioned further away from the traffic situation have sufficient time to react and thus, if applicable, adapt their driving behavior or avoid the traffic situation.

According to one embodiment, the degressive deceleration profile of the signal braking has a deceleration pulse as a first temporal feature of the deceleration profile.

This can achieve a technical advantage that the deceleration pulse causes the deceleration to start abruptly. This can alert the driver of the vehicle to the potentially safety-critical traffic situation. In addition, the deceleration pulse can achieve a strong deceleration and reduction of the driving speed of the vehicle. This further increases the safety of the vehicle.

According to one example embodiment of the present invention, the degressive deceleration profile of the signal braking has a deceleration flank arranged temporally after the deceleration pulse, wherein the deceleration flank has a lower deceleration value than the deceleration pulse.

This can achieve a technical advantage that, due to the deceleration flank which is executed temporally after the deceleration pulse and has a weaker deceleration value than the deceleration pulse, a comparatively gentle deceleration of the movement of the vehicle is effected after the abrupt start of the deceleration process. Due to the deceleration pulse, the driver can be alerted to a potentially safety-critical traffic situation. Due to the deceleration flank, which is executed later in time, a further reduction in speed can be effected. This does not have to be carried out abruptly since the driver has already been alerted by the deceleration pulse. In addition, the signal braking should not result in full braking, since, on the one hand, the current traffic situation is only potentially safety-critical and, on the other hand, the other road users positioned behind the vehicle in the direction of travel should not be unnecessarily endangered.

According to one example embodiment of the present invention, the deceleration pulse has a defined pulse amplitude and/or a predefined pulse width, and/or wherein the deceleration flank has a nearly constant profile.

This can achieve a technical advantage that a desired abrupt deceleration can be achieved by defining the pulse amplitude or pulse width of the deceleration pulse. Due to the nearly constant profile of the deceleration flank, a uniform reduction of the speed of the vehicle can be effected after the execution of the deceleration pulse. Due to the uniform reduction in speed, safe braking of the vehicle is made possible.

According to one example embodiment of the present invention, the deceleration value of the deceleration flank is sufficient to activate the brake light.

This can achieve a technical advantage that, because the deceleration value of the deceleration flank, which value is significantly lower than the pulse amplitude of the deceleration pulse, is large enough to activate the brake light, the brake light is activated for the entire deceleration duration of the signal braking.

According to one example embodiment of the present invention, the method further comprises:

Executing a safety check and ascertaining that the signal braking can be executed without endangering other road users, by a safety check module of the control unit.

This can achieve a technical advantage that the executed safety check can prevent any hazard caused to the other road users behind the vehicle by the execution of the safety braking operation.

According to one example embodiment of the present invention, the safety check comprises:

Ascertaining based on the environmental sensor data that a time gap between the vehicle and a following road user reaches or exceeds a predefined threshold value.

This can achieve a technical advantage that, by determining the time gap between the vehicle and the other road user positioned behind the vehicle in the direction of travel, a rear-end collision of the other road user with the vehicle during execution of the signal braking can be avoided. This can further improve the safety of the vehicle.

According to one example embodiment of the present invention, the safety check is executed in a rule-based manner.

This can achieve a technical advantage that a robust, rapid and traceable safety check can be executed.

According to one example embodiment of the present invention, the deceleration value and/or a deceleration duration of the deceleration profile of the signal braking is adjusted depending on the time gap between the vehicle and the following other road user.

This can achieve a technical advantage that the safety of the vehicle can be further improved. For this purpose, the deceleration value and/or the deceleration duration of the deceleration profile of the signal braking are adjusted depending on the time gap between the vehicle and the other road user positioned behind the vehicle. The smaller the time gap between the vehicle and the other road user, the shorter the deceleration value and/or the deceleration duration of the signal braking will be. Signal braking primarily serves to signal a potentially safety-critical traffic situation to, on the one hand, the driver of the vehicle and, on the other hand, the other road users. A significant deceleration of the vehicle is not necessary for this purpose. In particular, a correspondingly strong deceleration is avoided if the time gap between the vehicle and the nearest other road user does not allow such a strong deceleration and the associated strong reduction in speed.

According to one example embodiment of the present invention, the assessment of the traffic situation by the traffic situation assessment module is effected based on a multi-trajectory prediction method.

This can achieve a technical advantage that a powerful and robust traffic situation assessment module can be provided.

According to one example embodiment of the present invention, the assessment of the traffic situation by the traffic situation assessment module is effected based on at least one occupancy grid map.

This can achieve a technical advantage that a powerful and robust traffic situation assessment module can be provided.

According to one example embodiment of the present invention, the traffic situation assessment module is designed as a correspondingly trained artificial intelligence.

This can achieve the technical advantage that a powerful and robust traffic situation assessment module can be provided.

According to one example embodiment of the present invention, the traffic situation assessment module is designed as a correspondingly trained autoencoder, wherein the traffic situation is assessed by the traffic situation assessment module based on ascertaining a distance between a latent space representation of the traffic situation and latent space representations of known traffic situations.

This can achieve a technical advantage that the autoencoder and the representation of the traffic situation in a latent feature space make possible a reliable assessment of the traffic situation in relation to potential safety hazards. By ascertaining the distance between the latent space representation of the traffic situation and latent space representations of known traffic situations in the latent space (the latent feature space), the current traffic situation can be set in relation to previously known traffic situations. If the safety hazards of the already known traffic situations are known, the current traffic situation can thus be assessed in relation to its traffic hazard potential. This allows a precise assessment of the current traffic situation.

According to one example embodiment of the present invention, the traffic situation is assessed as potentially safety-critical if a distance between the latent space representation of the traffic situation and a cluster of latent space representations is less than or equal to a predefined threshold value and a safety hazard potential of the traffic situations represented by the latent space representations of the cluster is greater than or equal to a further predefined threshold value, and wherein the safety hazard potential of the traffic situations represented by the latent space representations of the cluster is defined as a proportion of the number of traffic situations of the cluster classified as safety-critical to a number of all traffic situations of the cluster.

This can achieve a technical advantage that a technically simple assessment of the traffic situation as a safety-critical traffic situation is made possible. Here, the current traffic situation is classified as safety-critical if the latent space representation representing the traffic situation is assigned to a cluster of latent space representations of known traffic situations based on the distance determination and if the number of traffic situations of the cluster classified as safety-critical compared to the total number of traffic situations of the cluster exceeds a predefined threshold value. Here, the ratio of the number of traffic situations in the cluster classified as safety-critical to the total number of traffic situations of the cluster can be interpreted as the probability that the current traffic situation is also safety-critical.

According to one aspect of the present invention, a computing unit is provided, which is configured to carry out the method for controlling a vehicle according to one of the above-described embodiments of the present invention.

According to one aspect of the present invention, a computer program product is provided, which comprises commands that, when the program is executed by a data processing unit, cause the data processing unit to carry out the method for controlling a vehicle according to one of the above-described embodiments of the present invention.

Example embodiments of the present invention are described with reference to the figures.

### BRIEF DESCRIPTION OF THE DRAWINGS

FIG. 1 shows a schematic representation of a system for controlling a vehicle according to one example embodiment of the present invention.

FIG. 2 shows a further schematic representation of the system for controlling a vehicle according to a further example embodiment of the present invention.

FIG. 3 shows a representation of a deceleration profile according to one example embodiment of the present invention.

FIG. 4 shows a flowchart of the method for controlling a vehicle according to one example embodiment of the present invention.

FIG. 5 shows a further flowchart of the method for driving a vehicle according to a further example embodiment of the present invention.

FIG. 6 shows a schematic representation of a computer program product, according to an example embodiment of the present invention.

### DETAILED DESCRIPTION OF EXAMPLE EMBODIMENTS

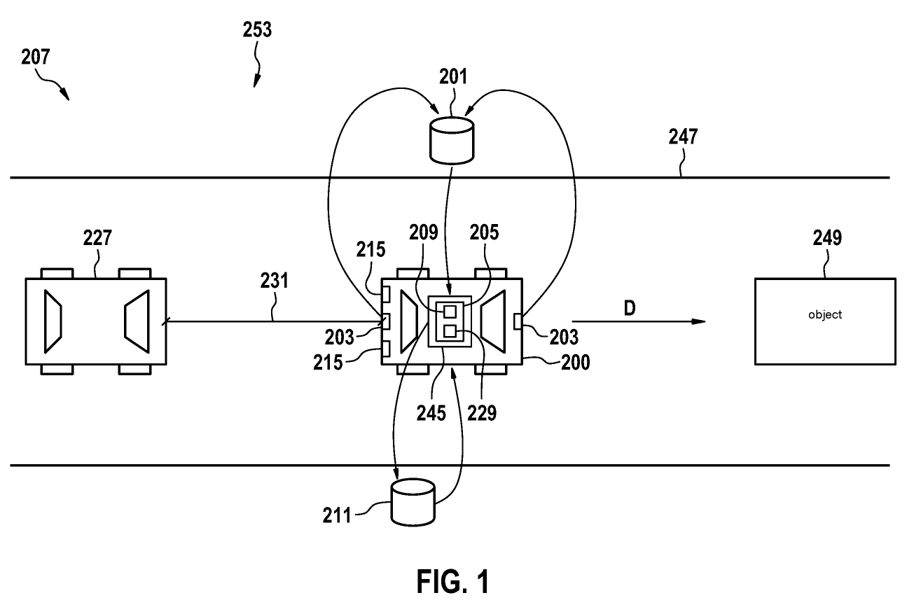

FIG. 1 is a schematic representation of a system 253 for controlling a vehicle 200 according to one embodiment.

FIG. 1 shows a traffic situation 207 with a vehicle 200 on a roadway 247. In the direction of travel D in front of the vehicle 200, there is an object 249 on the roadway 247. The traffic situation 207 thus is a potentially safety-critical traffic situation 207.

In relation to the direction of travel D, behind the vehicle 200, another road user 227 is shown in the form of a vehicle.

The vehicle 200 comprises a computing unit 245, on which a control unit 205 for controlling the vehicle 200 can be executed. In the embodiment shown, the control unit 205 comprises a traffic situation assessment module 209 and a safety monitoring module 229.

The vehicle 200 further comprises environmental sensors 203, via which environmental sensor data 201 can be provided. Here, the environmental sensor data 201 at least partially represent an environment of the vehicle 200. The environment sensors 203 can be designed, for example, as radar sensors, lidar sensors, ultrasonic sensors, or camera sensors.

According to the present invention, the control unit 205 receives the environmental sensor data 201 of the at least one environmental sensor 203. Based on the environmental sensor data 201, the traffic situation assessment module 209 assesses the current traffic situation, which is represented by the environmental sensor data 201.

If the traffic situation assessment module 209 ascertains that the current traffic situation 207 is potentially safety-critical, the control unit 205 outputs control signals 211 in order to effect a signal braking of the vehicle 200. Here, the signal braking is configured to reduce the speed of the vehicle and has a degressive deceleration profile.

According to one embodiment, due to the signal braking, the deceleration of the vehicle 200 is initiated with an uncomfortably large jerk. This can alert a driver of the vehicle 200 to the existing and potentially safety-critical traffic situation.

According to one embodiment, due to the signal braking, a brake light 215 of the vehicle 200 is also activated. By activating the brake light 215 of the vehicle 200, the potentially safety-critical traffic situation can be signaled to the other road user 227 positioned behind the vehicle 200 in the direction of travel D.

According to one embodiment, after assessing the potentially safety-critical traffic situation 207, the safety monitoring module 229 checks whether the signal braking can be executed by the vehicle 200 without endangering the other (usually rear) road user 227. For this purpose, the safety check module 229 can take into account the time gap 231 between the vehicle 200 and the other road user 227 and can assess whether the signal braking can be executed by the vehicle 200 if the ascertained time gap 231 is greater than or equal to a predefined threshold value.

According to a further embodiment, properties of the signal braking or of the deceleration profile can be adjusted depending on the time gap 231 between the vehicle 200 and the other road user 227. In particular, a deceleration value and/or a deceleration duration of the deceleration profile of the signal braking can be adjusted depending on the time gap 231.

According to one embodiment, the safety check is executed by the safety check module 229 in a rule-based manner.

According to one embodiment, the deceleration profile 213 of the signal braking has a deceleration pulse 217. The deceleration pulse 217 can be defined according to a defined pulse amplitude 223 and/or a defined pulse width 225.

According to a further embodiment, the deceleration profile 213 also has a deceleration flank 219, which is executed temporally after the deceleration pulse 217 and has a deceleration value 221 that is less than the pulse amplitude 223. The deceleration flank 219 can in particular have a nearly constant profile.

According to one embodiment, the brake light 215 is activated for the entire duration of execution of the signal braking.

According to one embodiment, the assessment of the traffic situation 207 by the traffic situation assessment module 209 is effected based on a multi-trajectory prediction method.

According to one embodiment, the assessment of the traffic situation 207 by the traffic situation assessment module is effected based on at least one occupancy grid map.

According to one embodiment, the traffic situation assessment module 209 is designed as a correspondingly trained artificial intelligence.

The potentially safety-critical traffic situation 207 shown in FIG. 1 is merely an example. By means of the method according to the present invention, a large number of different traffic situations 207 can be taken into account and assessed as potentially safety-critical according to a wide variety of aspects.

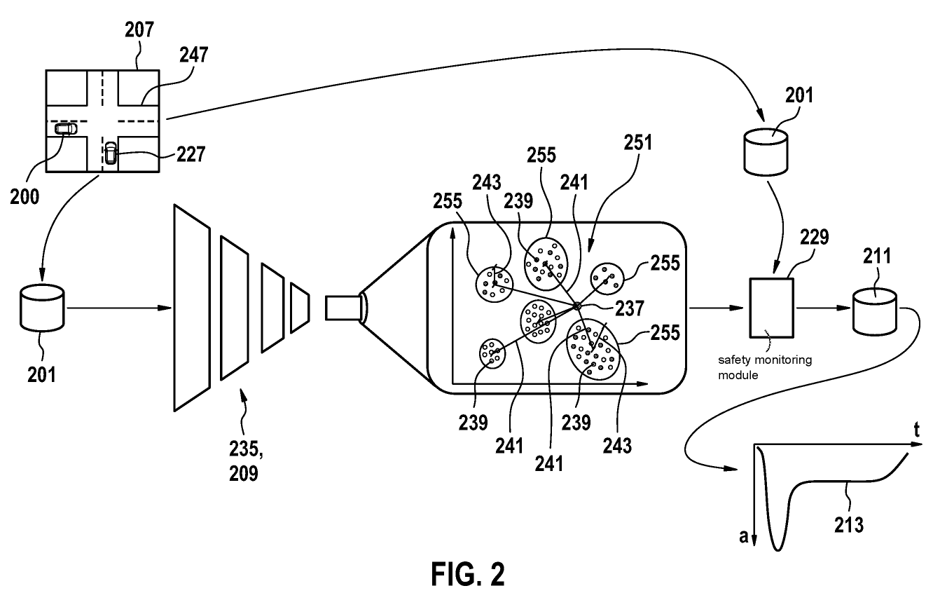

FIG. 2 is a further schematic representation of the system 253 for controlling a vehicle 200 according to a further embodiment.

In the embodiment shown, the traffic situation assessment module 209 is designed as an autoencoder 235. FIG. 1 shows only the trained encoder element of the autoencoder 235. The autoencoder 235 is configured to convert the environmental sensor data 201 representing the traffic situation 207 into corresponding latent space representations 237 of a latent feature space 251. In FIG. 2, a plurality of latent space representations 239 of already known traffic situations is shown in the latent feature space 251. The latent space representation 239 of the already known traffic situations were created during the training of the autoencoder 235 based on historical environmental sensor data and represent various historical traffic situations, which may be classified both as safety-critical and as non-safety-critical.

In the embodiment shown, the assessment of the current traffic situation 207 by determining the distance between the latent space representation 237 of the prevailing traffic situation 207 and the latent space representations 239 of the known traffic situations is effected by the traffic situation assessment module 209. If, when determining the distance of the latent space representation 237 of the current traffic situation 207, it is ascertained that the distance 241 of the latent space representation 237 to the latent space representations 239 of the known traffic situations is greater than or equal to a predefined distance 243, the current traffic situation 207 is assessed as potentially safety-critical.

In the embodiment shown, the latent space representations 239 of the known traffic situations are grouped into a plurality of clusters 255. Here, the traffic situations of a common cluster 255 represent very similar traffic situations. The individual known traffic situations are each also classified as safe or safety-critical. For this purpose, the corresponding latent space representations 239 can be provided with corresponding labels for indicating the safety value of the corresponding traffic situation. The classification into clusters 255 is carried out based on the particular type of traffic situations represented by the latent space representations 239, so that latent space representations 239 of similar traffic situations are arranged in common clusters 255. However, within a cluster 255, latent space representations 239 of traffic situations classified as safe and latent space representations 239 of traffic situations classified as safety-critical can be combined.

The circular or elliptical borders of the clusters 255 of the latent space representations 239 represent the maximum distances 243 that the latent space representations 239 can be from the center of the cluster 255 in order to still be assigned to the cluster 255. All latent space representations 239 with a smaller distance from one another than the predefined distance 243, i.e., which are located within the circle / ellipse, are parts of the common cluster 255 and thus have a high similarity of the corresponding traffic situations to one another.

The assessment of the current traffic situation with regard to the safety hazard potential is carried out by determining the distance between the corresponding latent space representation 237 and the latent space representation 239 of the known and classified traffic situations.

If the latent space representation 237 of the current traffic situation is assigned to a cluster 255 of latent space representation 239 via the ascertaining of the distance, the safety hazard potential of the corresponding traffic situation is ascertained based on the proportion of traffic situations classified as safety-critical to the total number of traffic situations of the cluster 255. The correspondingly ascertained proportion of traffic situations of the cluster 255 classified as safety-critical to the total number of traffic situations of the same cluster 255 is interpreted here as a probability value that the current traffic situation assigned to the cluster 255 is also safety-critical or could develop into safety-critical. If this probability value reaches or exceeds a predefined threshold value, the current traffic situation is assessed as potentially safety-critical.

In the example shown, the latent space representation 237 of the current traffic situation 207 is not assigned to any of the clusters 255 shown and has a distance to all clusters 255 that is greater than the maximum distances shown for the clusters 255. The traffic situation is thus unknown and cannot be clearly classified. In such a case, the traffic situation can also be classified as potentially safety-critical.

After the traffic situation assessment module 235 has classified the current traffic situation 207, the safety check module 229 checks, taking into account the environmental sensor data 201, whether a corresponding signal braking can be executed without endangering other road users 227.

If the safety check module 227 ascertains that the signal braking can be executed without endangering other road users 227, the control unit 205 provides the control signals 211, by which the deceleration profile 213 of the signal braking is defined.

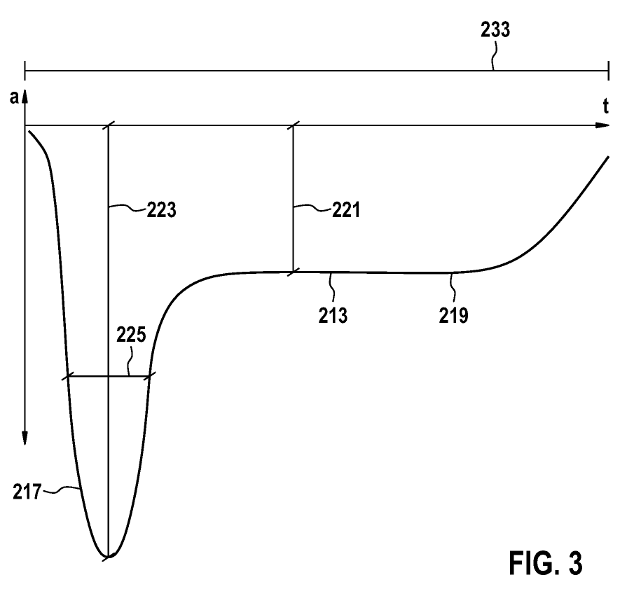

FIG. 3 is a representation of a deceleration profile 213 according to one embodiment.

In the embodiment shown, the deceleration profile 213 comprises the degressive profile according to the present invention. For this purpose, the deceleration profile 213 has the already mentioned deceleration pulse 217 as a first temporal feature. Temporally following the deceleration pulse 217, the deceleration profile 213 has the deceleration flank 219. In the embodiment shown, the deceleration flank 219 has a nearly constant profile.

The deceleration pulse 219 is defined by a pulse amplitude 223 and/or a pulse width 225. In the embodiment shown, the deceleration flank 219 has a deceleration value 221 that is substantially lower than the pulse amplitude 223 of the deceleration pulse 217. Due to the deceleration pulse 217 arranged first temporally, the brief and abrupt deceleration of the signal braking is effected. Due to the abrupt deceleration, the driver of the vehicle 200 is alerted to the current, potentially safety-critical traffic situation 207. Due to the nearly constant profile, or the profile approaching zero with a slight gradient, of the deceleration flank 219, which is executed later in time and has the significantly lower deceleration value 221, the driving speed of the vehicle 200 is reduced in a constant or degressive manner. Here, the signal braking is carried out over a deceleration duration 233.

Both the deceleration value 221, the pulse amplitude 223 and the deceleration duration 233 can be adjusted depending on the current traffic situation 207 and, if applicable, taking into account the other road users 227.

In FIG. 3, the deceleration of the signal braking is shown as a negative acceleration a.

The deceleration profile 213 shown in FIG. 3 represents only one possible embodiment of a possible signal braking.

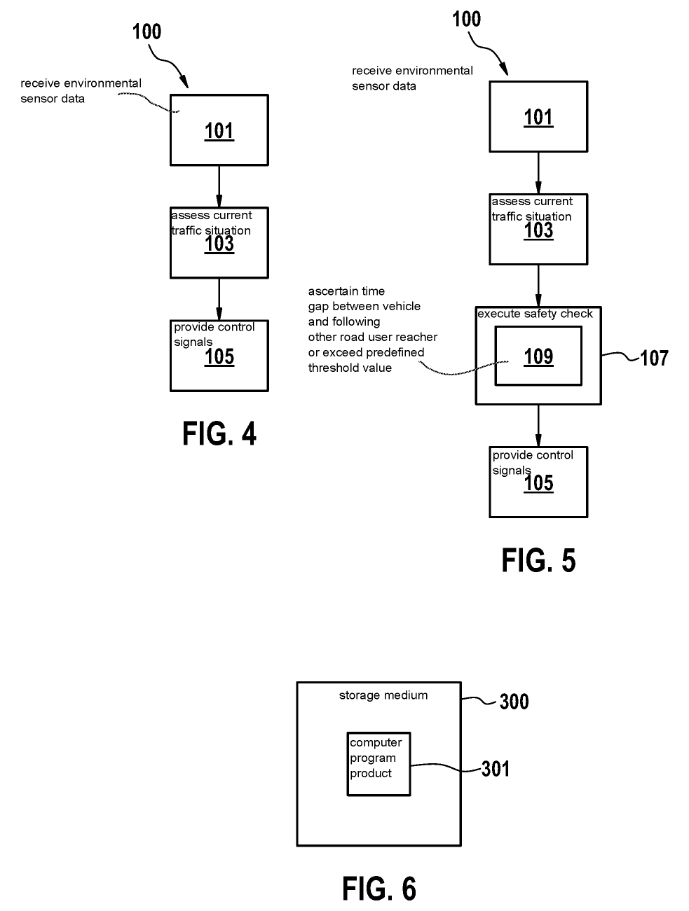

FIG. 4 is a further flowchart of the method 100 for controlling a vehicle 200 according to a further embodiment.

In a first method step 101, environmental sensor data 201 of the at least one environmental sensor 203 of the vehicle 200 are initially received by the control unit 205.

In a further method step 103, the current traffic situation 207 is assessed as potentially safety-critical by the traffic situation assessment module 209 based on the environmental sensor data 201.

In a further method step 105, control signals 211 are provided for executing the signal braking.

FIG. 5 is a further flowchart of the method 100 for controlling a vehicle 200 according to a further embodiment.

The embodiment in FIG. 5 is based on the embodiment in FIG. 4 and comprises all the method steps described there.

In the embodiment shown, in a method step 107, after assessing the traffic situation 207 by the safety check module 229, a safety check is executed and it is ascertained that the signal braking can be executed without endangering other road users 227.

For this purpose, in a method step 109, based on the environmental sensor data 201, it is ascertained that the time gap 231 between the vehicle 200 and the following other road user 227 reaches or exceeds a predefined threshold value. When the time gap 231 between the vehicle 200 and the following other road user 227 reaches or exceeds the predefined threshold value, a hazard to the following other road user 227 during execution of the signal braking is ruled out.

FIG. 6 is a schematic representation of a computer program product 301 comprising commands that, when the program is executed by a data processing unit, cause the data processing unit to carry out the method 100 for controlling a vehicle 200.

In the embodiment shown, the computer program product 301 is stored on a storage medium 300. Here, the storage medium 300 can be any storage medium from the related art.

What is claimed is:

1. A computer-implemented method for controlling a vehicle, comprising the following steps:
receiving environmental sensor data of at least one environmental sensor of the vehicle by a control unit of the vehicle, wherein the environmental sensor data at least partially represent an environment of the vehicle;
ascertaining a potentially safety-critical traffic situation based on the environmental sensor data by a traffic situation assessment module of the control unit; and
providing control signals by the control unit for executing signal braking, wherein the signal braking is configured to reduce a speed of the vehicle and has a degressive deceleration profile.

2. The method according to claim 1, wherein, due to the signal braking, an abrupt deceleration of a travel of the vehicle is effected.

3. The method according to claim 1 wherein, due to the signal braking, a brake light of the vehicle is activated.

4. The method according to claim 1, wherein the degressive deceleration profile of the signal braking has a deceleration pulse as a first temporal feature of the deceleration profile.

5. The method according to claim 4, wherein the degressive deceleration profile of the signal braking has a deceleration flank arranged temporally after the deceleration pulse, and wherein the deceleration flank has a lower deceleration value than the deceleration pulse.

6. The method according to claim 5, wherein: (i) the deceleration pulse has a defined pulse amplitude and/or a defined pulse width, and/or (ii) the deceleration flank has a nearly constant profile.

7. The method according to claim 5, wherein the deceleration value of the deceleration flank is sufficient to activate the brake light.

8. The method according to claim 1, further comprising:
executing a safety check and ascertaining that the signal braking can be executed without endangering other road users, by a safety check module of the control unit.

9. The method according to claim 8, wherein the executing of the safety check includes:
ascertaining based on the environmental sensor data that a time gap between the vehicle and a following road user reaches or exceeds a predefined threshold value.

10. The method according to claim 8, wherein the safety check is executed in a rule-based manner.

11. The method according to claim 9, wherein a deceleration value and/or a deceleration duration of the deceleration profile of the signal braking is adjusted depending on the time gap between the vehicle and the following other road user.

12. The method according to claim 1, wherein the assessment of the traffic situation by the traffic situation assessment module is effected based on a multi-trajectory prediction method.

13. The method according to claim 1, wherein the assessment of the traffic situation by the traffic situation assessment module is effected based on at least one occupancy grid map.

14. The method according to claim 1, wherein the traffic situation assessment module is a correspondingly trained artificial intelligence.

15. The method according to claim 1, wherein the traffic situation assessment module is a correspondingly trained autoencoder, and wherein the traffic situation is assessed by the traffic situation assessment module based on ascertaining a distance between a latent space representation of the traffic situation and latent space representations of known traffic situations.

16. The method according to claim 15, wherein the traffic situation is assessed as potentially safety-critical when a distance between the latent space representation of the traffic situation and a cluster of latent space representations is less than or equal to a predefined threshold value and a safety hazard potential of the traffic situations represented by the latent space representations of the cluster is greater than or equal to a further predefined threshold value, and wherein the safety hazard potential of the traffic situations represented by the latent space representations of the cluster is defined as a proportion of a number of the traffic situations of the cluster classified as safety-critical to a total number of all traffic situations of the cluster.

17. A computing unit for controlling a vehicle, the computing unit configured to perform the following steps:
receiving environmental sensor data of at least one environmental sensor of the vehicle by a control unit of the vehicle, wherein the environmental sensor data at least partially represent an environment of the vehicle;
ascertaining a potentially safety-critical traffic situation based on the environmental sensor data by a traffic situation assessment module of the control unit; and
providing control signals by the control unit for executing signal braking, wherein the signal braking is configured to reduce a speed of the vehicle and has a degressive deceleration profile.

18. A non-transitory computer-readable medium on which is stored a computer program product including commands for controlling a vehicle, the commands, when executed by a data processing unit, causing the data processing unit to perform the following steps:
receiving environmental sensor data of at least one environmental sensor of the vehicle by a control unit of the vehicle, wherein the environmental sensor data at least partially represent an environment of the vehicle;
ascertaining a potentially safety-critical traffic situation based on the environmental sensor data by a traffic situation assessment module of the control unit; and
providing control signals by the control unit for executing signal braking, wherein the signal braking is configured to reduce a speed of the vehicle and has a degressive deceleration profile.
